(19) United States
(12) Patent Application Publication
(10) Pub. No.: US 2009/0223738 A1
(43) Pub. Date: Sep. 10, 2009

(54) SOUND ABSORBING STRUCTURE AND VEHICLE COMPONENT HAVING SOUND ABSORPTION PROPERTY

(75) Inventors: Yasutaka Nakamura, Hamamatsu-shi (JP); Rento Tanase, Hamamatsu-shi (JP); Kunio Hiyama, Hamamatsu-shi (JP); Atsushi Yoshida, Hamamatsu-shi (JP); Masaru Matsushita, Hamamatsu-shi (JP)

Correspondence Address: DICKSTEIN SHAPIRO LLP, 1177 AVENUE OF THE AMERICAS (6TH AVENUE), NEW YORK, NY, 10036-2714, US

(73) Assignee: Yamaha Corporation, Hamamatsu-shi (JP)

(21) Appl. No.: 12/388,282

(22) Filed: Feb. 18, 2009

(30) Foreign Application Priority Data
Feb. 22, 2008 (JP) 2008-041772
Mar. 5, 2008 (JP) 2008-055367
Mar. 18, 2008 (JP) 2008-069794
Mar. 18, 2008 (JP) 2008-069795
Apr. 14, 2008 (JP) 2008-104965
Apr. 22, 2008 (JP) 2008-111481
Aug. 28, 2008 (JP) 2008-219129
Aug. 29, 2008 (JP) 2008-221316
Sep. 1, 2008 (JP) 2008-223442

(51) Int. Cl. G10K 11/00

(52) U.S. Cl. 181/175

(57) ABSTRACT

A sound absorbing structure is constituted of a housing and a vibration member. The vibration member composed of a synthetic resin having elasticity is constituted of a first member and a second member whose surface density is smaller than the surface density of the first member, wherein the first member is fixed into a center hole of the second member so as to form a single board of the vibration member. Since the surface density of the center portion of the vibration member is higher than the surface density of the peripheral portion of the vibration member, the frequency of absorbed sound further decreases in comparison with the foregoing structure in which the vibration member is increased in weight to change the frequency of absorbed sound. This makes it possible to arbitrarily change the frequency of absorbed sound without substantially changing the overall weight of the sound absorbing structure.

### BACKGROUND OF THE INVENTION

1. Field of the Invention

The present invention relates to sound absorbing structures adapted to sound chambers, and in particular to vehicle components having sound absorbing properties.

The present application claims priority on Japanese Patent Application No. 2008-41772, Japanese Patent Application No. 2008-55367, Japanese Patent Application No. 2008-69794, Japanese Patent Application No. 2008-104965, Japanese Patent Application No. 2008-69795, Japanese Patent Application No. 2008-111481, Japanese Patent Application No. 2008-223442, Japanese Patent Application No. 2008-221316, and Japanese Patent Application No. 2008-219129, the contents of which are incorporated herein by reference in their entirety.

2. Description of the Related Art

Conventionally, various types of sound absorbing structures have been developed and disclosed in various documents such as Patent Document 1.

Patent Document 1: Japanese Unexamined Patent Application Publication No. 2006-11412

Patent Document 1 discloses a sound absorbing structure (hereinafter, referred to as a panel/membrane-vibration sound absorbing structure) which absorbs sound by a vibration member composed of a panel or membrane and an air cavity formed on the backside of the vibration member. The panel/membrane-vibration sound absorbing structure is recognized as a spring-mass system which is constituted of a mass of the vibration member and a spring component of the air cavity. When the vibration member having elasticity performs bending vibration, the property of a bending system due to bending vibration is added to the property of the spring-mass system.

By increasing the density of the vibration member, it is possible for the panel/membrane-vibration sound absorbing structure to decrease the frequency of absorbed sound, thus decreasing the pitch of absorbed sound. However, the total mass of the vibration member becomes large as the density of the vibration member increases, thus increasing the overall weight of the sound absorbing structure. It becomes difficult to apply the sound absorbing structure having a heavy weight to the existing field which requires weight reductions. In addition, when the sound absorbing structure having a heavy weight is disposed on a wall surface, it is necessary to arrange a high-strength support structure bearing the weight of the sound absorbing structure, which is thus difficult to be simply disposed on the wall surface.

### SUMMARY OF THE INVENTION

It is an object of the present invention to provide a technology for changing the property of absorbed sound without substantially changing the overall weight of a sound absorbing structure having a vibration member.

In one embodiment of the present invention, a sound absorbing structure is constituted of a housing having a hollow portion and an opening, and a vibration member composed of a panel or membrane. The opening of the housing is closed with the vibration member so as to form an air cavity inside the housing. The density of at least a part of the vibration member except for a first area causing a node or minimum amplitude of bending vibration differs from the density of the first area of the vibration member. Alternatively, the density of the vibration member at a second area causing the maximum amplitude of bending vibration differs from the density of the vibration member except for the second area.

It is possible to modify the sound absorbing structure in such a way that the thickness of at least a part of the vibration member except for the first area causing a node or minimum amplitude of bending vibration differs from the thickness of the first area of the vibration member. Alternatively, the thickness of the vibration member at the second area causing the maximum amplitude of bending vibration differs from the thickness of the vibration member except for the second area

It is possible to modify the sound absorbing structure in such a way that a secondary member is attached to a part of the vibration member except for the first area causing the node or minimum amplitude of bending vibration. Alternatively, the secondary member is attached to the vibration member at the second area causing the maximum amplitude of bending vibration. In this connection, the secondary member is attached to the surface of the vibration member or incorporated into the vibration member.

In another embodiment of the present invention, a grouped sound absorbing structure is composed of a plurality of sound absorbing structures. Herein, the weights of the secondary members attached to the vibration members differ from each other with respect to the respective sound absorbing structures. Alternatively, the sizes or thicknesses of the air cavities formed in the housings differ from each other with respect to the respective sound absorbing structures.

A sound chamber can be formed using the above sound absorbing structure or the above grouped sound absorbing structure.

In a further embodiment of the present invention, an adjustment method is adapted to the sound absorbing structure so as to change the density or thickness of the vibration member except for the first area, thus adjusting the resonance frequency of the sound absorbing structure. Alternatively, an adjustment method is adapted to the sound absorbing structure so as to change the secondary member, thus adjusting the resonance frequency of the sound absorbing structure.

In a further embodiment of the present invention, a noise reduction method is adapted to the sound absorbing structure so as to reduce noise by the vibration member.

The present invention demonstrates the outstanding effect for arbitrarily changing or adjusting the frequency of absorbed sound without substantially changing the overall weight of the sound absorbing structure and its vibration member.

### BRIEF DESCRIPTION OF THE DRAWINGS

FIG. 1 is a perspective view showing the external appearance of a sound absorbing structure according to a first embodiment of the present invention.

FIG. 2 is an exploded perspective view of the sound absorbing structure.

FIG. 3 is a cross-sectional view of the sound absorbing structure.

FIG. 4 is a graph showing the simulation result of the sound absorbing structure.

FIG. 5 is a cross-sectional view of a sound absorbing structure according to a first variation of the first embodiment.

FIG. 6 is a graph showing the measurement result regarding sound absorption coefficients of sound absorbing structures according to variations of the first embodiment.

FIG. 7 is a cross-sectional view of a sound absorbing structure according to a second variation of the first embodiment.

FIG. 8 is a cross-sectional view of a sound absorbing structure according to a third variation of the first embodiment.

FIG. 9 is a perspective view showing the external appearance of a grouped sound absorbing structure.

FIG. 10 is an exploded perspective view of a sound absorbing structure according to a fourth variation of the first embodiment.

FIG. 11 is a perspective view showing the external appearance of a vehicle adopting sound absorbers according to a second embodiment of the present invention.

FIG. 12 is a side view showing a chassis of the vehicle.

FIG. 13 is an enlarged sectional view of a position Pa in FIG. 12.

FIG. 14 is an exploded perspective view related to FIG. 13.

FIG. 15 is a perspective view showing the external appearance of a vehicle adopting sound absorbers according to a third embodiment of the present invention.

FIG. 16 is a graph showing a noise reduction effect in a rear seat by a sound absorber installed in a roof of the vehicle.

FIG. 17 is a development illustration of a sun visor adopting a sound absorber according to a fourth embodiment of the present invention.

FIG. 18 is a sectional view taken along line A-A in FIG. 17.

FIG. 19 is a sectional view showing a sound absorber according to a fifth embodiment of the present invention, which is installed in a rear pillar of a vehicle.

FIG. 20 is a sectional view showing a variation of the sound absorber shown in FIG. 19.

FIG. 21 is a sectional view showing a sound absorber according to a sixth embodiment of the present invention, which is installed in a door of a vehicle.

FIG. 22 is a sectional view showing a modified example of the sound absorber shown in FIG. 21.

FIG. 23 is a partly cut plan view showing a sound absorber according to a seventh embodiment of the present invention, which is installed in a floor of a vehicle.

FIG. 24 is an illustration used for explaining the sound absorption principle of a sound absorber composed of plural pipes.

FIG. 25A is a perspective view showing a modified example of the seventh embodiment.

FIG. 25B is an illustration showing a side sill of the floor viewed in an X-direction of FIG. 25A.

FIG. 26 is a perspective view showing the external appearance of an instrument panel of a vehicle adopting a sound absorber according to an eighth embodiment of the present invention.

FIG. 27 is a sectional view taken along line X-X in FIG. 26, which shows the internal structure of the instrument panel arranging plural sound absorbers.

FIG. 28 is an illustration viewed in an I-direction in FIG. 27, which shows the arrangement of plural sound absorbers.

FIG. 29 is a perspective view showing the external appearance of an instrument panel adopting a sound absorber according to a modified example of the eighth embodiment.

FIG. 30 is a sectional view taken along line Y-Y in FIG. 29, which shows the arrangement of plural sound absorbers according to the modified example.

FIG. 31A is a sectional view showing an example in which a panel-vibration sound absorbing structure according to a ninth embodiment of the present invention is installed inside the instrument panel.

FIG. 31B is a plan view of the upper side of the instrument panel shown in FIG. 31A.

FIG. 31C is a plan view showing an example in which plural sound absorbers forming the panel-vibration sound absorbing structure installed inside the instrument panel are aligned in parallel with left-right directions of a vehicle.

FIG. 31D is a sectional view showing an example in which the panel-vibration sound absorbing structure is installed in a tray beneath a rear glass of a vehicle.

FIG. 31E is a sectional view showing an example in which the panel-vibration sound absorbing structure is installed in the lower portion of a floor of a vehicle.

FIG. 32A is a sectional view showing an example in which a panel-vibration sound absorbing structure composed of plural housings each aligning plural sound absorbers is installed inside a front seat of a vehicle.

FIG. 32B is a sectional view showing an example in which a panel-vibration sound absorbing structure composed of plural housings each aligning plural sound absorbers is installed inside a rear seat of a vehicle.

FIG. 33A is a sectional view showing a panel-vibration sound absorbing structure according to a first modified example of the ninth embodiment.

FIG. 33B is a sectional view showing a panel-vibration sound absorbing structure according to a second modified example of the ninth embodiment.

FIG. 33C is a sectional view showing a panel-vibration sound absorbing structure according to a third modified example of the ninth embodiment.

FIG. 33D is a sectional view showing a panel-vibration sound absorbing structure according to a fourth modified example of the ninth embodiment.

FIG. 33E is a sectional view showing a panel-vibration sound absorbing structure according to a fifth modified example of the ninth embodiment.

### DESCRIPTION OF THE PREFERRED EMBODIMENTS

### 1. First Embodiment

### (A) Sound Absorbing Structure

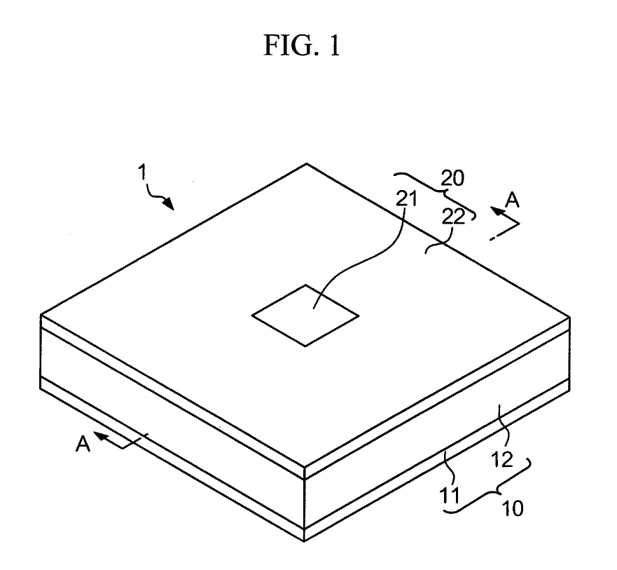

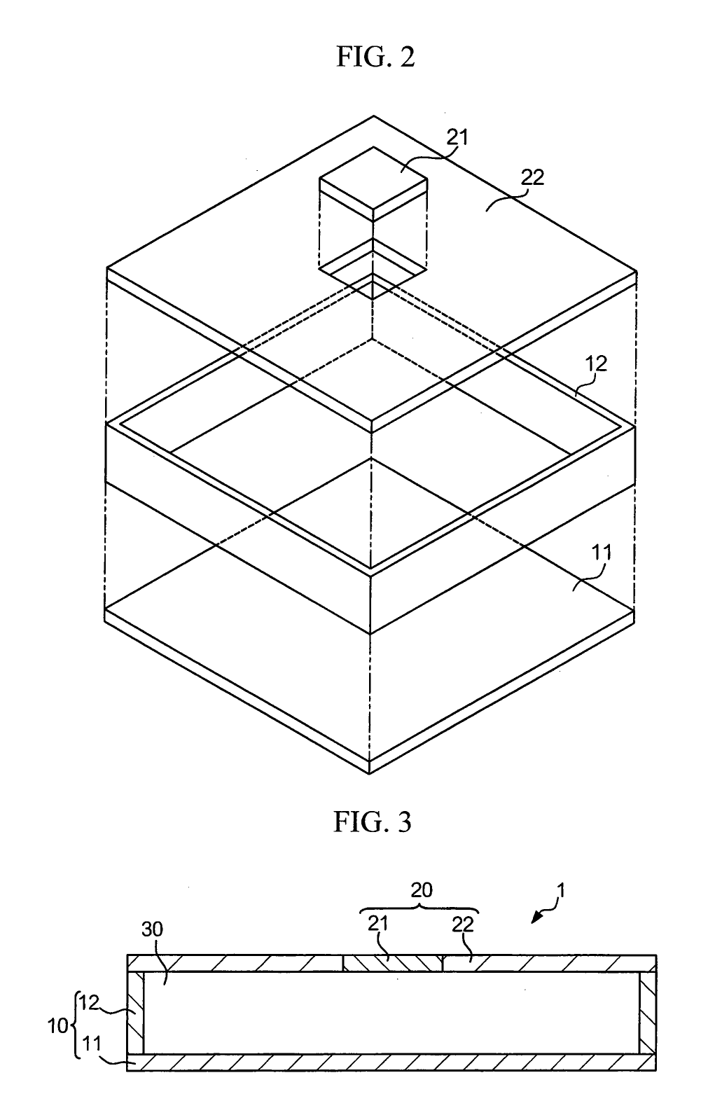

FIG. 1 shows the external appearance of a sound absorbing structure 1 according to a first embodiment of the present invention. FIG. 2 is an exploded perspective view of the sound absorbing structure 1, and FIG. 3 is a cross-sectional view taken along line A-A in FIG. 2. In these drawings, the illustrated shape and dimensions of the sound absorbing structure 1 do not precisely match those of an actual product of the sound absorbing structure 1 in order to simply illustrate the present embodiment in an easy-to-understand manner.

The sound absorbing structure 1 is constituted of a housing 10 and a vibration member 20. The housing 10 composed of a synthetic resin is formed in a rectangular parallelepiped shape whose cross section is shaped in a square and which has an opening at one end thereof while the other end thereof is closed, so that the housing 10 has a bottom portion 11 surrounded by a side wall 12.

The vibration member 20 is constituted of a first member 21 which is a square-shaped small board composed of a synthetic resin having elasticity, and a second member 22. When a force is applied to the vibration member 20, the vibration member 20 is temporarily deformed but is restored in shape due to elasticity so as to cause a vibration. The second member 22 is composed of a synthetic resin having elasticity such that the surface density thereof is smaller than that of the first member 21. The second member 22 has a square hole at the center thereof. The thickness of the first member 21 is identical to the thickness of the second member 22. The first member 21 is fixed in the square-shaped hole of the second member 22 so as to form the vibration member 20 as an integrally unified board.

The material of the vibration member 20 is not necessarily limited to the synthetic resin; hence, the vibration member 20 can be composed of other materials having elasticity and causing panel vibration, such as paper, metals, and fibered boards.

The area of the first member 21 within the plane of the vibration member 20 includes a prescribed position at which an amplitude of the vibration member 20 subjected to bending vibration becomes maximum. In this connection, the area of the first member 21 is not necessarily limited to the illustrated position and area and can be changed arbitrarily as long as it contains the prescribed position having the maximum amplitude of the vibration member 20 subjected to bending vibration.

The bottom portion 11 is fixed to the side wall 12 so as to form the housing 10; then, the vibration member 20 is bonded to the rectangular opening of the housing 10 so as to form an air cavity 30 defined inside the sound absorbing structure 1 (or on the backside of the vibration member 20). A sound absorbing mechanism of a spring-mass system is formed using a mass of the vibration member 20 and a spring component of the air cavity 30 in the sound absorbing structure 1. Since the vibration member 20 having elasticity causes bending vibration in the sound absorbing structure 1, a sound absorbing structure of a bending system due to bending vibration is added to the property of the sound absorbing structure 1. The air cavity 30 is not necessarily closed so that few holes are formed in the housing 10 so as to allow the air cavity 30 to communicate with the external space.

In the sound absorbing structure 1, when sound waves reach the vibration member 20, the vibration member 20 vibrates due to the difference between the sound pressure of sound waves and the internal pressure of the air cavity 30, so that energy of sound waves is consumed due to vibration of the vibration member 20. Since the sound absorbing structure 1 adopts both of the sound absorbing mechanisms of the spring-mass system and bending system, the sound absorption coefficient becomes high at the resonance frequency of the spring-mass system and the resonance frequency of the bending system in connection with the relationship between the frequency of absorbed sound and the sound absorption coefficient.

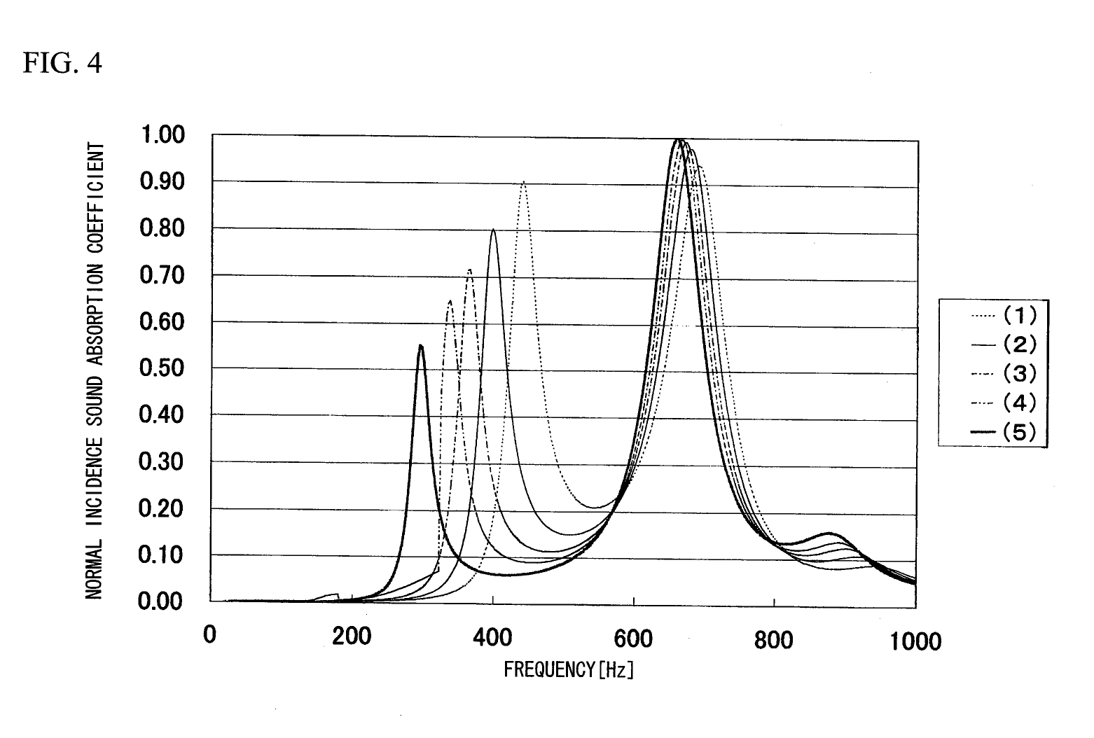

FIG. 4 is a graph showing the simulation result of the normal incidence sound absorption coefficient of the sound absorbing structure 1 in which the vibration member 20 (having longitudinal/lateral dimensions of 100 mm×100 mm and a thickness of 0.85 mm) is attached to the housing 10 (containing the air cavity 30 having longitudinal/lateral dimensions of 100 mm×100 mm and a thickness of 10 mm) and in which the first member 21 (having longitudinal/lateral dimensions of 20 mm×20 mm and a thickness of 0.85 mm) is varied in surface density. Herein, simulation is performed based on JIS A 1405-2 (titled “Acoustics—Determination of sound absorption coefficient and impedance in impedance tubes—Part 2: Transfer-function method”), wherein the sound field of an acoustic tube disposing the sound absorbing structure is calculated in accordance with the finite element method and boundary element method, wherein sound absorption characteristics are calculated based on the transfer function.

TABLE 1

| Condition | SD1 [g/m²] | ASD [g/m²] | F_{RB} [Hz] | F_{RSM} [Hz] |
|---|---|---|---|---|
| (1) | 399.5 | 783 | 440 | 690 |
| (2) | 799 | 799 | 400 | 680 |
| (3) | 1,199 | 815 | 365 | 670 |
| (4) | 1,598 | 831 | 337 | 665 |
| (5) | 2,379 | 862.9 | 295 | 660 |

Table 1 shows the simulation result regarding a resonance frequency F_{RB} [Hz] of the bending system and a resonance frequency F_{RSM} [Hz] of the spring-mass system based on the conditions (1) to (5), in which a surface density SD2 [g/m²] of the second member 22 is fixed to “799” while a surface density SD1 [g/m²] of the first member 21 is varied at “399.5” in (1), “799” in (2), “1,199” in (3), “1,598” in (4), and “2,397” in (5), and an average surface density ASD [g/m²] of the vibration member 20 is varied at “783” in (1), “799” in (2), “815” in (3), “831” in (4), and “862.9” in (5).

The condition (2) is directed to the simulation result in which the vibration member 20 is entirely composed of the same material so that the surface density SD1 of the first member 21 is identical to the surface density SD2 of the second member 22, wherein the resonance frequency F_{RB} becomes a peak at 400 Hz in response to a 1×1 mode of natural vibration.

According to the simulation result shown in FIG. 4, the sound absorption coefficient rapidly increases in the frequency range between 300 Hz and 500 Hz and in proximity to 700 Hz. The peak of the sound absorption coefficient occurs around 700 Hz due to the resonance of the spring-mass system composed of the mass of the vibration member 20 and the spring component of the air cavity 30. The sound absorbing structure 1 absorbs sound with a peak sound absorption coefficient at the resonance frequency F_{RSM} of the spring-mass system, wherein the mass of the vibration member 20 does not vary irrespective of an increase of the surface density SD1 of the first member 21, so that the resonance frequency F_{RSM} of the spring-mass system does not vary substantially.

The sound absorption coefficient spikes in the frequency range between 300 Hz and 500 Hz due to the resonance of the bending system caused by the bending vibration of the vibration member 20. In the sound absorbing structure 1, a peak sound absorption coefficient in a low frequency range appears at the resonance frequency F_{RB} of the bending system, wherein the simulation result clearly shows that only the resonance frequency F_{RB} of the bending system decreases as the surface density SD1 of the first member 21 increases. In general, the resonance frequency F_{RB} of the bending system is determined by the equation of motion dominating elastic vibration of the vibration member and is inversely proportional to the surface density of the vibration member. In addition, the resonance frequency F_{RB} of the bending system is greatly affected by the density at the antinode of natural vibration (whose amplitude becomes maximum). In the simulation, the first member 21 is changed in the surface density SD1 in connection with the antinode of the 1×1 mode of natural vibration, thus varying the resonance frequency F_{RB} of the bending system.

As described above, a peak sound absorption coefficient in the lower frequency range moves further into the lower frequency range when the surface density SD1 of the first member 21 becomes higher than the surface density SD2 of the second member 22. This indicates that the peak sound absorption coefficient shifts (or moves) further into the lower frequency range or to a higher frequency range by varying the surface density SD1 of the first member 21.

The sound absorbing structure 1 allows the peak sound absorption coefficient to be shifted in the frequency range by simply varying the surface density SD1 of the first member 21. Compared with the foregoing sound absorbing structure in which the vibration member is entirely composed of the same material and is increased in weight so as to change the frequency of absorbed sound, it is possible for the present embodiment to decrease the frequency of absorbed sound without substantially changing the overall weight of the sound absorbing structure 1.

### (B) Variations

The present embodiment is not necessarily limited to the sound absorbing structure 1 but can be modified in various ways.

The vibration member 20 having elasticity can be formed in other shapes such as membranes (e.g. films and sheets) other than panels. Herein, panels have two-dimensional areas of three-dimensional (rectangular parallelepiped) shapes having small thicknesses, while membranes are further reduced in thickness compared with panels so as to gain restoration force by way of tension force.

In the present embodiment, the first member 21 has a square shape in plan view, which can be changed with other shapes such as rectangular shapes, trapezoidal shapes, polygonal shapes, circular shapes, and elliptical shapes. Even when the first member 21 does not have a square shape in plan view, it is possible to lower the frequency of absorbed sound compared with the foregoing sound absorbing structure whose vibration member is entirely composed of the same material in the condition in which the surface density of the prescribed area causing the maximum amplitude of bending vibration of the vibration member 20 is higher than the surface density of the second member 22.

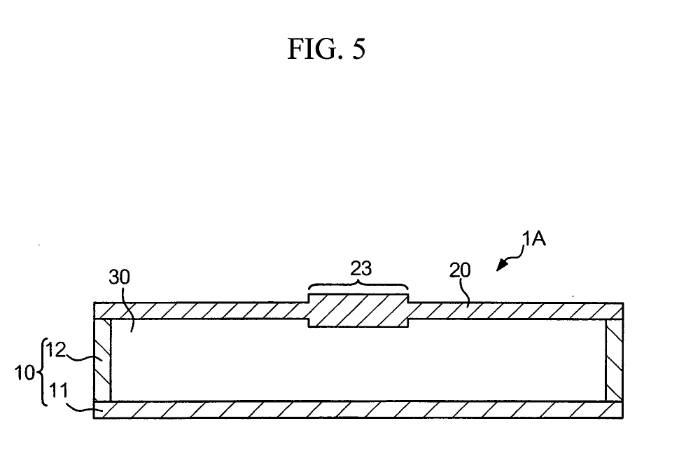

In the present embodiment, the first member 21 whose surface density is higher than the surface density of the second member 22 is arranged in the prescribed area causing the maximum amplitude of bending vibration of the vibration member 20; but this is not a restriction. That is, it is possible to design a sound absorbing structure 1A shown in FIG. 5 in which the vibration member 20 is entirely composed of the same material and in which a first region 23 including the area causing the maximum amplitude of bending vibration (corresponding to approximately the center of the vibration member 20) is increased in thickness compared with the peripheral portion of the vibration member 20.

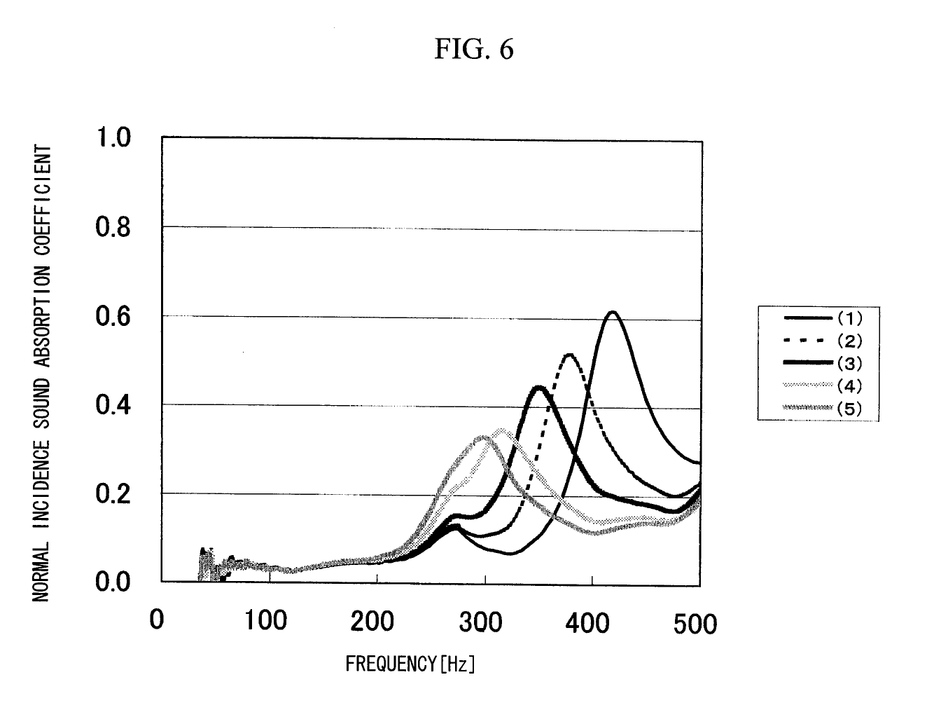

FIG. 6 is a graph regarding the measurement result of the normal incidence sound absorption coefficient of the sound absorbing structure 1A based on JIS A 1405-2 (titled “Acoustics—Determination of sound absorption coefficient and impedance in impedance tubes—Part 2: Transfer-function method”), in which the vibration member 20 (having longitudinal/lateral dimensions of 100 mm×100 mm) having a surface density of 800 [g/m²] is fixed to the housing 10 (having longitudinal/lateral dimensions of 100 mm×100 mm and thickness of 10 mm) and in which the thickness of the first region 23 is changed in conditions (1) to (5) such that it is identical to the thickness of the peripheral portion of the vibration member 20 (i.e. 0.85 mm) in (1), it is double the thickness of the peripheral portion in (2), it is triple the thickness of the peripheral portion in (3), it is four times the thickness of the peripheral portion in (4), and it is five times the thickness of the peripheral portion in (5).

The graph of FIG. 6 clearly shows that a peak sound absorption coefficient occurs in the frequency range between 200 Hz and 500 Hz at the resonance frequency F_{RB} of the bending system corresponding to the vibration member 20 in the sound absorbing structure 1A, wherein the resonance frequency F_{RB} decreases as the thickness of the first region 23 increases.

The above measurement result indicates that the frequency of absorbed sound decreases as the thickness of the first region 23 (including the prescribed area causing the maximum amplitude of bending vibration) increases. In addition, it also indicates that the frequency of absorbed sound can be varied by varying the thickness of the first region 23.

Since the sound absorbing structure 1A is designed to change the frequency of absorbed sound by changing the thickness of the first region 23, it is possible to decrease the frequency of absorbed sound without substantially changing the overall weight of the sound absorbing structure 1A compared to the foregoing sound absorbing structure whose vibration member is increased in weight so as to change the frequency of absorbed sound. In this connection, it is possible to vary the thickness of the first region 23 in such a way that the first region 23 is gradually increased in thickness from the peripheral portion of the vibration member 20. In addition, it is possible to arbitrarily change the shape and dimensions of the first region 23 as long as the first region 23 includes the prescribed area causing the maximum amplitude of bending vibration of the vibration member 20.

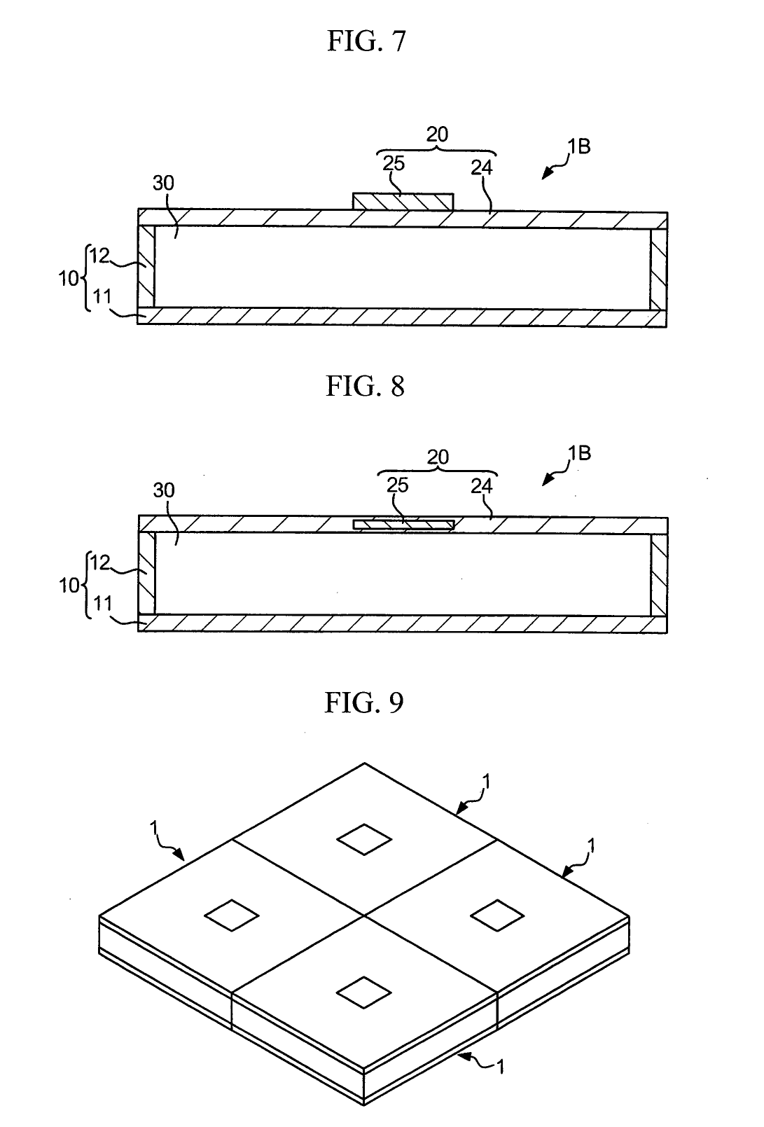

It is possible to provide a sound absorbing structure 1B shown in FIG. 7 in which the vibration member 20 is constituted of a primary member 24 (having a rectangular shape in plan view) and a secondary member 25. The primary member 24 is a square-shaped member composed of an elastic material, while the secondary member 25 is a rectangular material which is integrally fixed to the primary member 24.

In the vibration member 20 shown in FIG. 7, the secondary member 25 is adhered to the prescribed region (i.e. the first region 23 shown in FIG. 5) including the prescribed area causing the maximum amplitude of bending vibration of the primary member 24. In the sound absorbing structure 1B, the secondary member 25 can be attached to the interior surface of the vibration member 20 attached to the housing 10 so as to directly face the air cavity 30. Alternatively, the secondary member 25 can be attached to the exterior surface of the vibration member 20 opposite to the air cavity 30.

In the above constitution, the weight of the center portion of the vibration member 20 included in the sound absorbing structure 1B is heavier than the weight of the center portion of the foregoing vibration member which is entirely composed of the same material. That is, it is possible to decrease the resonance frequency of the bending system in the sound absorbing structure 1B compared to the foregoing sound absorbing structure whose vibration member is entirely composed of the same material; this makes it possible to change the frequency of absorbed sound by changing the weight of the secondary member 25.

It is possible to modify the sound absorbing structure 1B as shown in FIG. 8 such that the secondary member 25 is incorporated into the prescribed region of the primary member 24 including the prescribed area causing the maximum amplitude of bending vibration of the vibration member 20. In the sound absorbing structure 1B, the secondary member 25, which is incorporated into the prescribed region of the primary member 24 including the prescribed area causing the maximum amplitude of bending vibration of the vibration member 20, is not necessarily formed in a rectangular shape but can be replaced with a plurality of grains whose density is higher than the density of the primary member 24. Alternatively, the secondary member 25 can be replaced with a plurality of linear members whose density is higher than the density of the primary member 24.

The above sound absorbing structures 1, 1A, and 1B according to the first embodiment and its variations can be each installed in sound chambers whose acoustic characteristics are controlled, such as soundproof chambers, halls, theaters, listening rooms of audio devices, and conference rooms as well as spaces of transportation systems and housings or casings of speakers and musical instruments.

It is possible to assemble a plurality of sound absorbing structures (e.g. sound absorbing structures 1, 1A, and 1B) having the same dimensions and shape to form a grouped sound absorbing structure as shown in FIG. 9. When a plurality of sound absorbing structures 1 show in FIG. 1 is assembled together, it is possible to change the surface density of the first member 21 with respect to each of the sound absorbing structures 1, thus achieving sound absorption at various frequencies.

When a plurality of sound absorbing structures 1A shown in FIG. 5 is assembled together, it is possible to change the thickness of the first region 23 with respect to each of the sound absorbing structures 1A, thus achieving sound absorption at various frequencies. When a plurality of sound absorbing structures 1B shown in FIGS. 7 and 8 is assembled together, it is possible to change the as of the secondary member 25 with respect to each of the sound absorbing structures 1B, thus achieving sound absorption at various frequencies. A plurality of sound absorbing structures can be assembled together by changing the thickness of the air cavity 30 while fixing longitudinal/lateral dimensions of the air cavity 30 with respect to each sound absorbing structure. Alternatively, it is possible to change longitudinal/lateral dimensions of the air cavity 30 while fixing the thickness of the air cavity 30 with respect to each sound absorbing structure. Furthermore, it is possible to change both the longitudinal/lateral dimensions and the thickness of the air cavity 30 with respect to each sound absorbing structure.

It is possible to provide a sound absorbing structure shown in FIG. 10, in which the inside space of the housing 10 is partitioned using a grid-shaped partition member 13 so as to form plural sections of the air cavity 30, which are covered with the vibration member 20. A plurality of secondary members 25 is adhered onto the exterior surface of the primary member 24 of the vibration member 20 at regions which are opposite to the plural sections of the air cavity 30 and each of which includes the prescribed area causing the maximum amplitude of bending vibration of the vibration member 20. In this constitution, it is possible to change the weight of each secondary member 25. Thus, it is possible to achieve sound absorption at various frequencies.

It is possible to arrange each of the first member 21, the secondary member 25, and the first region 23 at another position each including the prescribed area causing the maximum amplitude of bending vibration of the vibration member 20 other than the center portion of the vibration member 20.

Alternatively, it is possible to arrange each of the first member 21 and the secondary member 25 at the periphery of the prescribed area causing the maximum amplitude of bending vibration in the vibration member 20. Herein, the thickness of the periphery of the prescribed area causing the maximum amplitude of bending vibration of the vibration member 20 can be increased to be larger than the thickness of the prescribed area of the vibration member 20.

It is possible to arrange each of the first member 21 and the secondary member 25 on at least a part of the vibration member 20 except for the prescribed area causing the node or minimum amplitude of bending vibration. Herein, the thickness of the periphery of the prescribed area causing the node or minimum amplitude of bending vibration can be increased to be larger than the thickness of the prescribed area of the vibration member 20.

In the present embodiment, the vibration member 20 is fixed to the housing 10, thus limiting the displacement (or movement) and rotation at the fixed point. Alternatively, the vibration member 20 can be simply supported by the housing 10 so as to limit the displacement thereof relative to the housing 10 but to allow the rotation thereof.

It is possible to establish a simply supported state (limiting the displacement) or a freely supported state between the vibration member 20 and the housing 10. Alternatively, it is possible to form a complex vibration structure combining the aforementioned vibration members.

It is possible to realize the constitution in which the density of a part of the vibration member 20 other than the prescribed area causing the node or minimum amplitude of bending vibration differs from the density of the prescribed area of the vibration member 20 by adopting different densities to the first member 21 and the second member 22. Herein, a plurality of first members 21 having different densities is prepared in advance and is each selected for use in the second member 22. Thus, it is possible to adjust the resonance frequency of the spring-mass system and the resonance frequency of the bending system, thus adjusting the frequency causing the peak sound absorption coefficient.

In the constitution in which the thickness of a part of the vibration member 20 other than the prescribed area causing the node or minimum amplitude of bending vibration differs from the thickness of the prescribed area of the vibration member 20, it is possible to adjust the resonance frequency of the spring-mass system and the resonance frequency of the bending system by reducing the thickness of the first region 23 via cutting or by increasing the thickness of the first region 23 using an additional member (which is composed of the same material as the vibration member 20), thus adjusting the frequency causing the peak sound absorption coefficient.

It is possible to realize the constitution in which the secondary member 25 is added to a part of the vibration member 20 except for the prescribed area causing the node or minimum amplitude of bending vibration. Herein, a plurality of secondary members 25 having different densities is prepared in advance and is each selected for use in the primary member 24. Thus, it is possible to adjust the resonance frequency of the spring-mass system and the resonance frequency of the bending system, thus adjusting the frequency causing the peak sound absorption coefficient.

According to the above adjustment method applied to the sound absorbing structure, it is possible to easily adjust the resonance frequency of the spring-mass system and the resonance frequency of the bending system, thus adjusting the frequency causing the peak sound absorption coefficient with ease.

It is possible to locate the sound absorbing structure, in which the density of a part of the vibration member 20 (constituted of the first member 21 and the second member 22) except for the prescribed area causing the node or minimum amplitude of bending vibration differs from the density of the prescribed area of the vibration member 20, at the place causing noise whose frequency matches the frequency causing the peak sound absorption coefficient.

It is possible to locate the sound absorbing structure, in which the vibration member 20 does not have uniform thickness so that the thickness of a part of the vibration member 20 except for the prescribed area causing the node or minimum amplitude of bending vibration differs from the thickness of the prescribed area of the vibration member 20, at the place causing noise whose frequency matches the frequency of the peak sound absorption coefficient.

It is possible to locate the sound absorbing structure, in which the secondary member 25 is disposed in a part of the vibration member 20 (constituted of the primary member 24 and the secondary member 25) except for the prescribed area causing the node or minimum amplitude of bending vibration, at the place causing noise whose frequency matches the frequency causing the peak sound absorption coefficient.

According to the above noise reduction method in which the sound absorbing structure is located at the place causing noise so as to reduce noise, the vibration member 20 vibrates so as to consume energy of noise, thus reducing noise.

As the places causing noise, it is possible to list the internal spaces of transportation systems such as vehicles and airplanes, factories, and machines operated at construction sites.

### 2. Second Embodiment

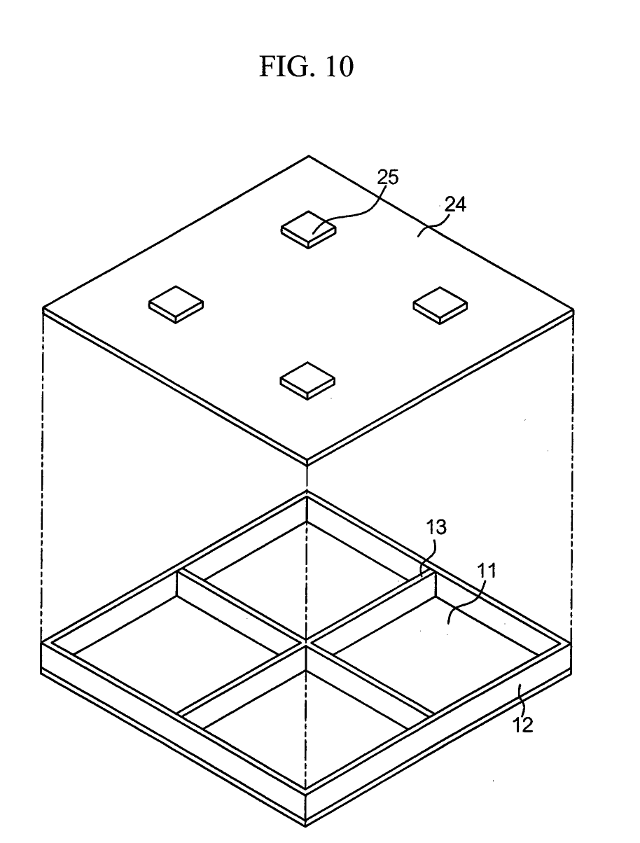

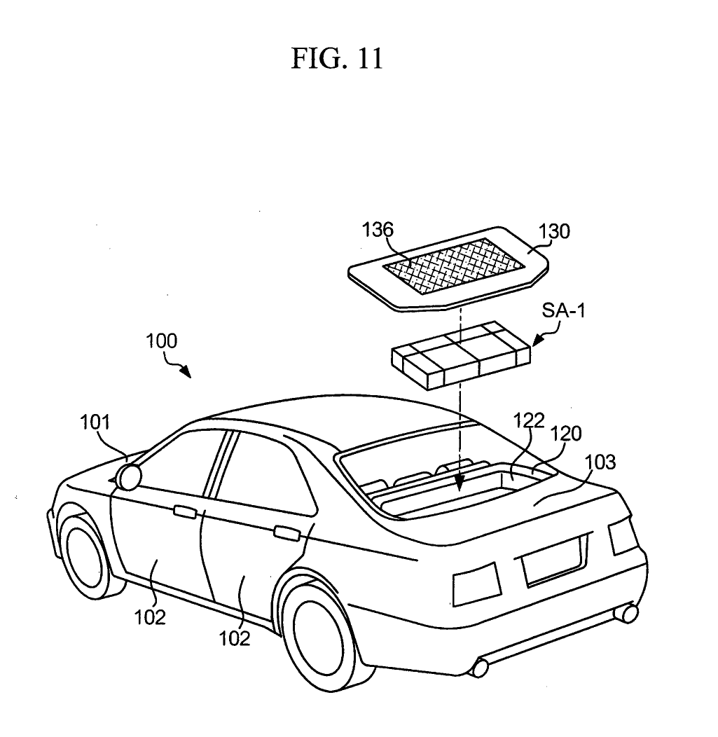

FIG. 11 is a perspective view showing the external appearance of a four-door sedan vehicle 100 adopting a sound absorber SA_1 according to a second embodiment of the present invention. In the vehicle 100, a hood (or a bonnet) 101, four doors 102, and a trunk door 103 are each attached to a chassis 110 corresponding to a base of a vehicle structure in an open/close manner.

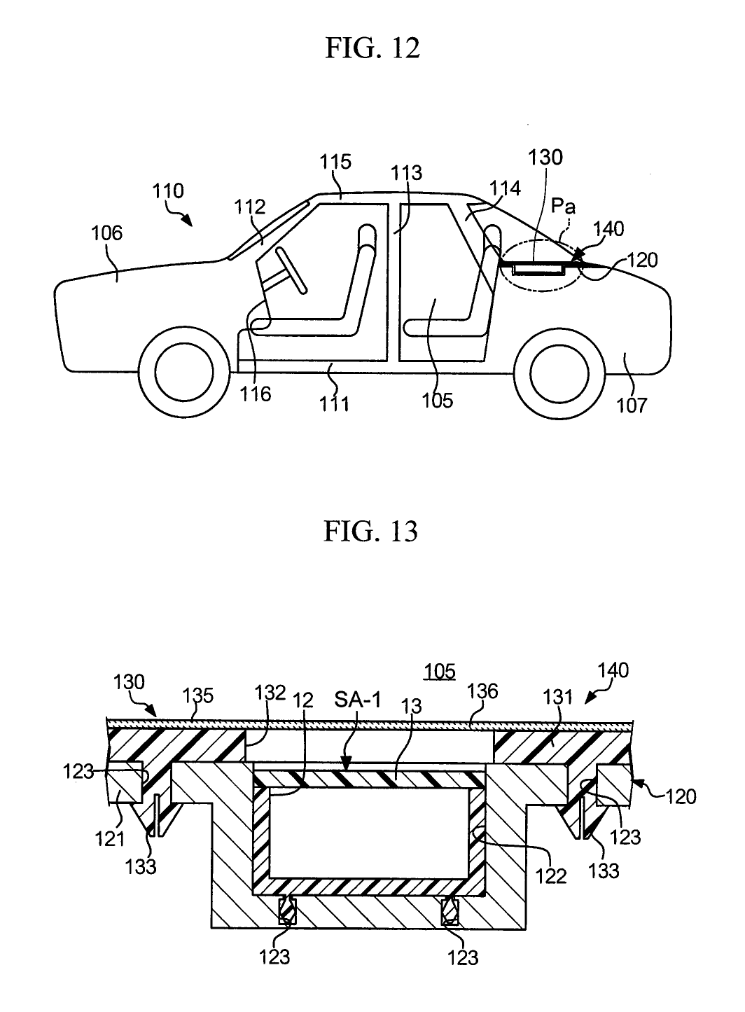

FIG. 12 is a side view showing the chassis 110 of the vehicle 100. The chassis 110 is equipped with a floor 111, a front pillar 112 extending upwardly from the floor 111, a center pillar 113, a rear pillar 114, a roof 115 (which is supported by the pillars 112, 113, and 114), an engine partition 116 for partitioning the internal space of the vehicle 100 into a compartment 105 and an engine room 106, and a trunk partition 120 for partitioning between the compartment 105 and a luggage space 107. The trunk partition 120 is equipped with a rear package tray 130.

As shown in FIG. 12, the trunk partition 120 includes a back support of a rear seat and is thus bent in an L-shape in cross section.

The following description is based on the premise that the trunk partition 120 partitions between the compartment 105 and the luggage space 107.

The second embodiment is characterized in that the box-shaped sound absorber SA_1 is attached to the trunk partition 120 of the chassis 110. FIG. 13 is a cross-sectional view of a position Pa in FIG. 10, and FIG. 12 is an exploded sectional view for assembling the sound absorber SA_1 with the trunk partition 120. FIGS. 13 and 14 show a single sound absorber SA_1; in actuality, a plurality of sound absorbers SA_1 having different shapes is installed in the trunk partition 120 as show in FIG. 11. In this connection, the shape of the sound absorber SA_1 is similar to or identical to the shape of the trunk partition 120 for partitioning between the compartment 105 and the luggage space 107.

As shown in FIG. 13, the rear package tray 130 is attached to the trunk partition 120 so as to form a trunk board 140.

The rear package tray 130 is constituted of a core material 131 composed of a wooden fiber board and a fabric having acoustic transmissivity. The surface of the core material 131 is covered with a surface material 135. A through-hole 132 having a rectangular opening is formed in a part of the core material 131 positioned opposite to the sound absorber SA_1. That is, the through-hole 132 of the surface material 135 forms an acoustic transmitter 136 which transmits sound pressure occurring in the compartment 105 toward the sound absorber SA_1. The opening shape of the through-hole 132 is not necessarily limited to the rectangular shape, which can be changed to a circular shape. That is, the opening shape of the through-hole 132 is determined to transmit air of the compartment 105 to the sound absorber SA_1.

### 3. Third Embodiment

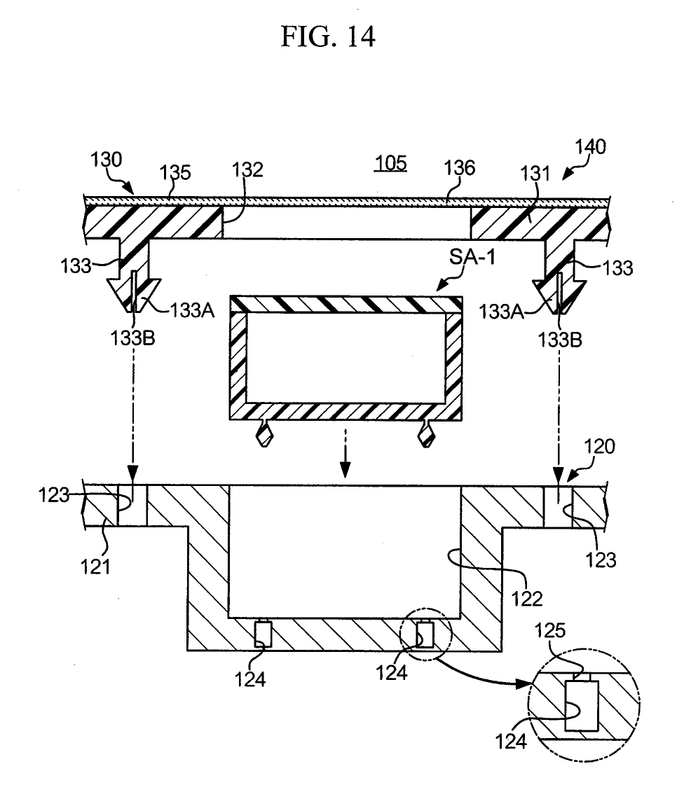

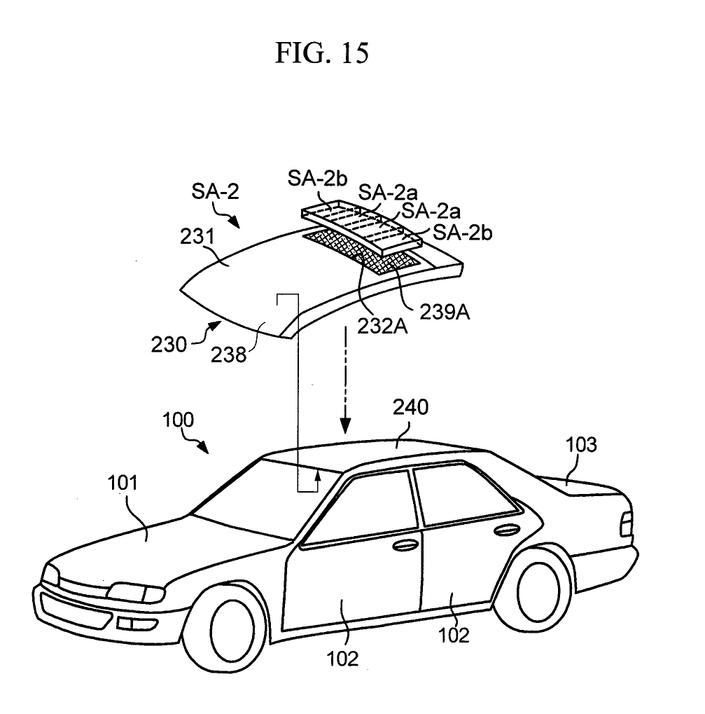

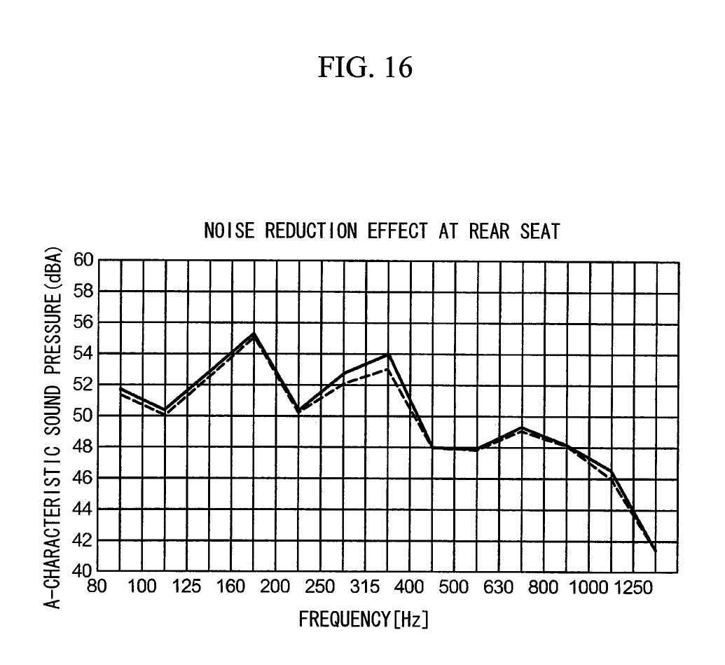

A third embodiment of the present invention will be described with reference to FIGS. 15 and 16. In FIG. 15, the constituent elements identical to those shown in FIGS. 11 and 12 are designated by the same reference numerals.

FIG. 15 is a perspective view showing the external appearance of the four-door sedan vehicle 100 adopting a sound absorber SA_2 according to the third embodiment of the present invention. The hood 101, the four doors 102, and the trunk door 103 are each attached to the chassis 110 corresponding to the base of the vehicle structure in an open/close manner. The chassis 110 of the vehicle 100 is formed as shown in FIG. 12. Compared to the second embodiment in which the sound absorber SA_1 is attached to the rear package tray 130, the third embodiment is designed to attach the sound absorber SA_2 to a roof 240. The roof 240 is constituted of a roof outer panel (corresponding to the roof 115 in FIG. 10) and a roof inner panel 230.

The third embodiment is characterized in that the box-shaped sound absorber SA_2 is attached to the roof 240 of the vehicle 100. In FIG. 15, the sound absorber SA_2 includes four sound absorbers SA_2a and SA_2b having different sizes in total.

In the roof 240, the roof inner panel 230 is clipped to the roof outer panel forming a part of the chassis 110.

In the roof inner panel 230, the surface of a core material 231 composed of a wooden fiber board is covered with a surface material 238 composed of a fabric having acoustic transmissivity. A rectangular through-hole 232A is formed in the core material 231 in proximity to the rear seat, wherein a part of the surface material 238 positioned opposite to the through-hole 232A forms an acoustic transmitter 239A. The sound absorber SA_2 communicates with the compartment 105 via the acoustic transmitter 239A. The acoustic transmitter 239A is not necessarily attached to the roof 240 in proximity to the rear seat, which can be changed to the front seat. FIG. 16 is a graph showing a noise reduction effect at the rear seat.

### 4. Fourth Embodiment

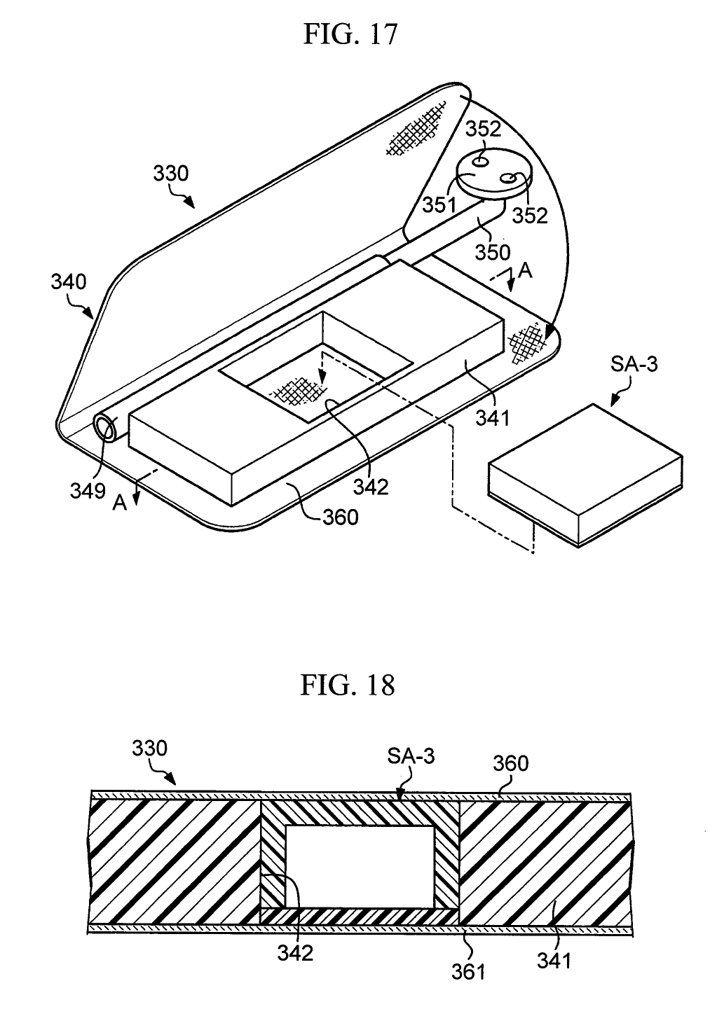

A fourth embodiment is characterized in that a box-shaped sound absorber SA_3 is attached to a sun visor 330 of the vehicle 100. FIG. 17 is a development of the sun visor 330 attached to the upper portion of the roof 115 of the vehicle 100, and FIG. 18 is a cross-sectional view taken along line A-A in FIG. 17.

The sun visor 330 is constituted of a panel-shaped light insulation portion 340 and an L-shaped support shaft 350 for supporting the light insulation portion 340 in a rotatable manner.

The light insulation portion 340 is constituted of a core material 341 composed of an ABC resin (or engineering plastic) and a surface material 360 composed of a nonwoven fabric having acoustic transmissivity. The core material 341 is covered with the surface material 360 in such a way that respective sides of the surface material 360 are bonded together so as to cover the surface and backside of the core material 341.

A bracket 351 used for attaching the sun visor 330 to the roof 115 is unified with one end of the support shaft 350. A pair of screw holes 352 is formed in the bracket 351. The sun visor 330 is fixed to the roof 115 by screwing the bracket 351 to a predetermined position of the roof 115.

A rectangular through-hole 342 used for attaching the sound absorber SA_3 is formed in the core material 341. The through-hole 342 of the surface material 360 serves as an acoustic transmitter 361.

### 5. Fifth Embodiment

A fifth embodiment is characterized in that a box-shaped sound absorber SA_4 is attached to the rear pillar 114. In actuality, it is possible to attach a plurality of sound absorbers SA_4 having different shapes to the rear pillar 114.

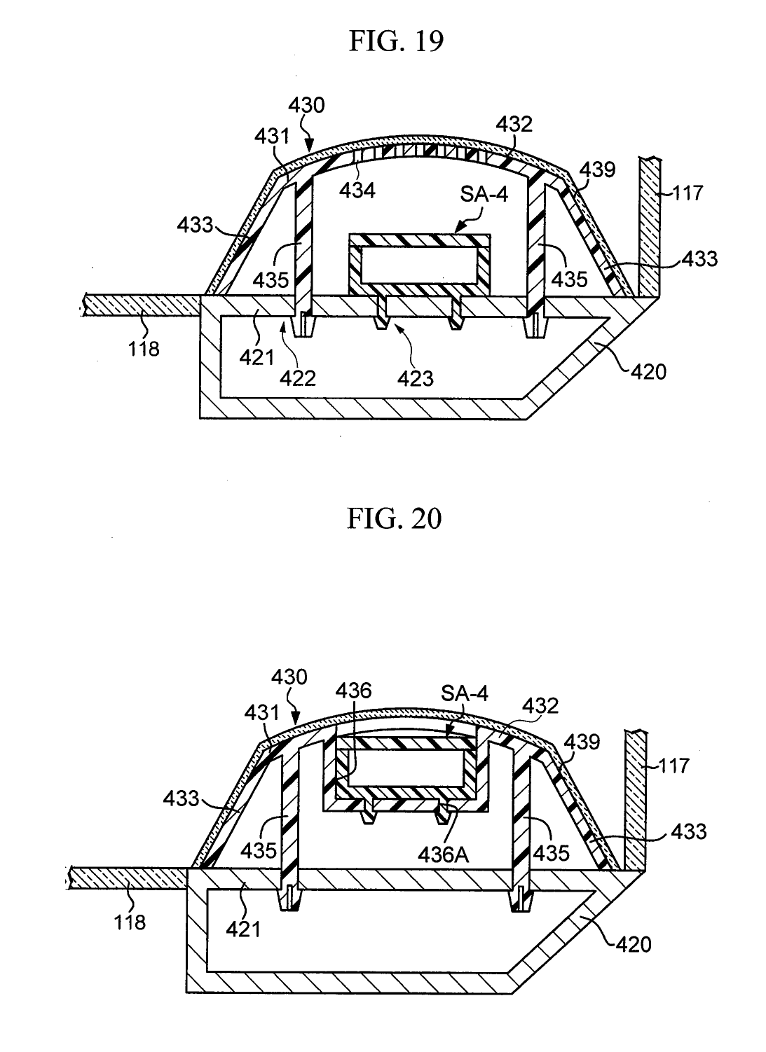

FIG. 19 is a cross-sectional view of the sound absorber SA_4 attached to the rear pillar 114. The rear pillar 114 is equipped with a rear outer panel 420 (which forms a part of the chassis 110) and a rear inner panel 430 (which is attached to the rear outer panel 420).

The rear outer panel 420 is formed using a planar portion 421 of a rectangular parallelepiped shape having a trapezoidal cross section. Fitting holes 422 fitted with the rear inner panel 430 and fitting holes 423 fitted with projections of the sound absorber SA_4 are formed in the planar portion 421. A rear glass 117 is disposed at one end of the rear outer panel 420 via a seal (not shown), and a door glass 118 is disposed at the other end of the rear outer panel 420 via a seal (not shown).

The rear inner panel 430 is constituted of a core material 431 composed of a polypropylene resin and a surface material 439 composed of a fabric having acoustic transmissivity, wherein the surface of the core material 431 is covered with the surface material 439.

The core material 431 is constituted of a circular portion 432 and an incline portion 433 (which extends outside of the circular portion 432). A plurality of through-holes 434 is formed in the circular portion 432. The rear pillar 114 communicates with the compartment 105 via the through-holes 434.

FIG. 20 shows a variation of the fifth embodiment in which the sound absorber SA_4 is inserted into a rectangular recess 436 of the core material 431, which is opened in the compartment 105. Fitting holes 436A are formed in the bottom portion of the recess 436. The sound absorber SA_4 is fixed inside the recess 436 while the projections thereof are inserted into the fitting holes 436A.

The present embodiment is designed to attach the sound absorber SA_4 to the rear pillar 114; but this is not a restriction. For instance, it is possible to attach the sound absorber SA_4 to the front pillar 112 or the center pillar 113.

### 6. Sixth Embodiment

A sixth embodiment is characterized in that a box-shaped sound absorber SA_5 is attached to the door 102 of the vehicle 100.

The interior of the door 102 includes a door-trim base 520, an interior material 530, an armrest 540, and a door pocket 550. The interior material 530 is constituted of the door-trim base 520 composed of a synthetic resin and a surface material 535 composed of a nonwoven fabric having acoustic transmissivity. The surface of the door-trim base 520 is covered with the surface material 535.

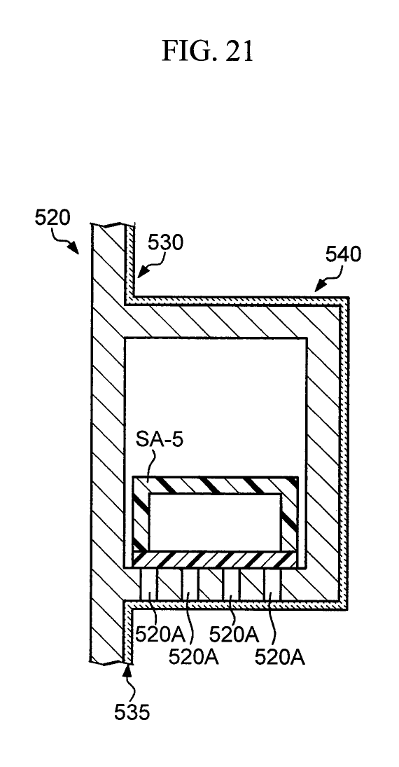

FIG. 21 shows that the sound absorber SA_5 is installed inside the armrest 540 in communication with a plurality of through-holes 520A formed in the door-trim base 520.

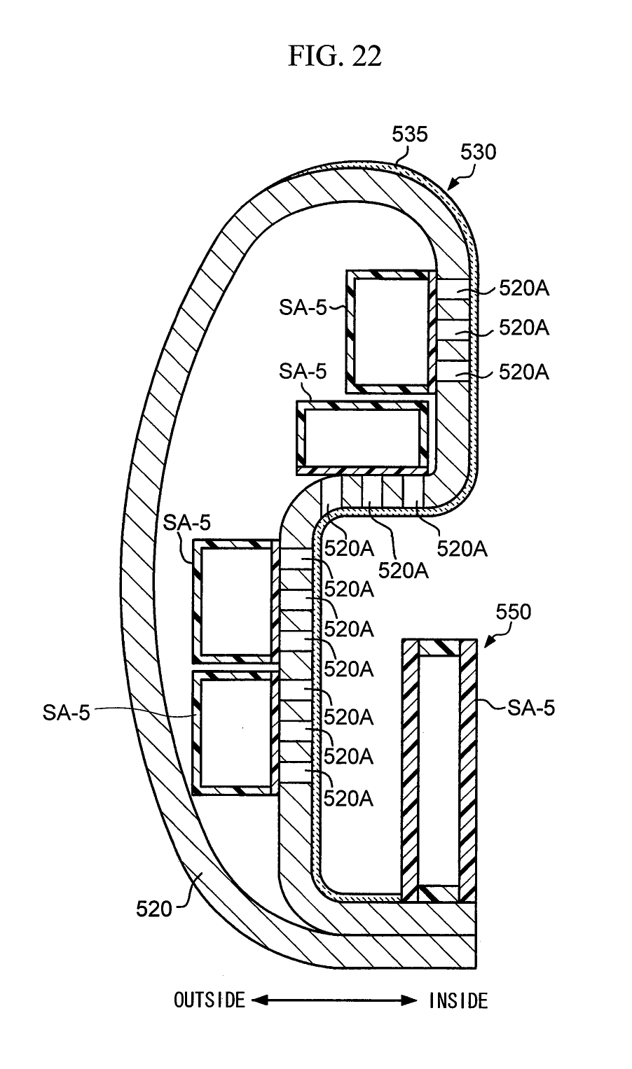

FIG. 22 shows that a plurality of sound absorbers SA_5 is installed inside the interior material 530 in communication with a plurality of through-holes 520A, while another sound absorber SA_5 is used for the door pocket 550.

### 7. Seventh Embodiment

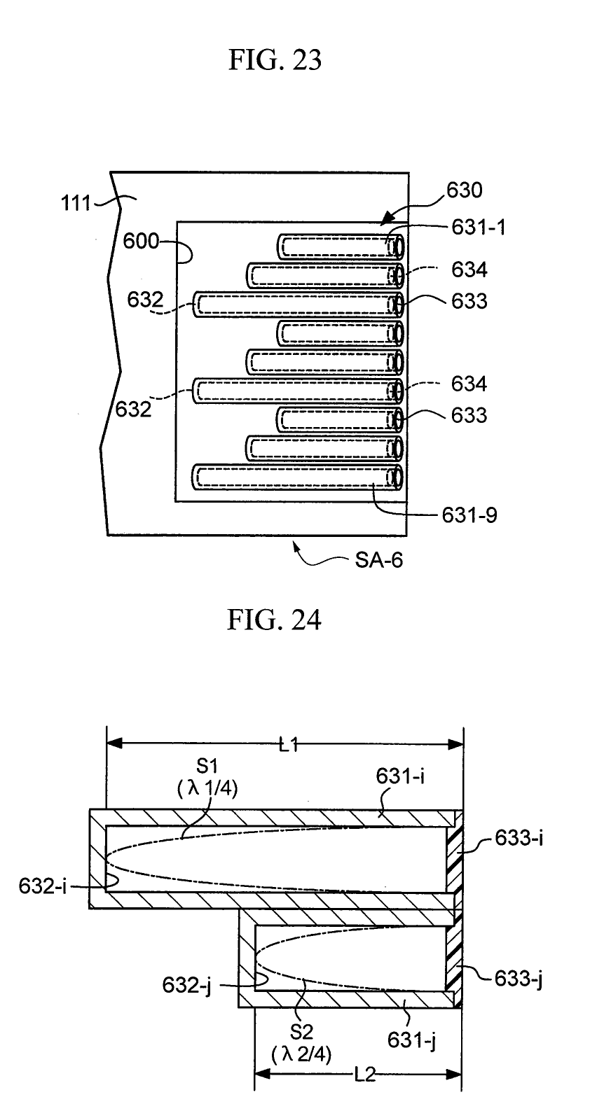

A seventh embodiment is characterized in that a sound absorber SA_6 composed of a plurality of sound absorbing pipes is installed in the floor 111 of the vehicle 100. As shown in FIG. 23, a sound absorber 630 (i.e., the sound absorber SA_6) is installed in a recess 600 formed in the floor 111.

The sound absorber 630 is formed by interconnecting and unifying a plurality of pipes 631 (e.g. 631-1 to 631-9) having different lengths which are linearly aligned. Each pipe 631 is a linear rigid pipe which is composed of a synthetic resin and whose cross section has a circular shape. One end of each pipe 631 is closed in the form of a closed portion 632, while the other end is opened in the form of an opening (serving as an acoustic transmitter) 633, wherein the inside of each pipe 631 is a hollow portion 634. The opening 633 of each pipe 631 communicates with the compartment 105 via a gap which is formed when the door 102 is closed.

FIG. 24 shows the relationship between adjacent pipes 631-i and 631-j whose hollow portions have different lengths L1 and L2. Sound waves of wavelengths λ1 and λ2 (where L1=¼, L2= 2/4), which are four times longer than the lengths L1 and L2, create standing waves S1 and S2, which in turn cause vibrations repeatedly propagating in the pipes 631-i and 631-j so as to consume acoustic energy, thus achieving sound absorption about the wavelengths λ1 and λ2.

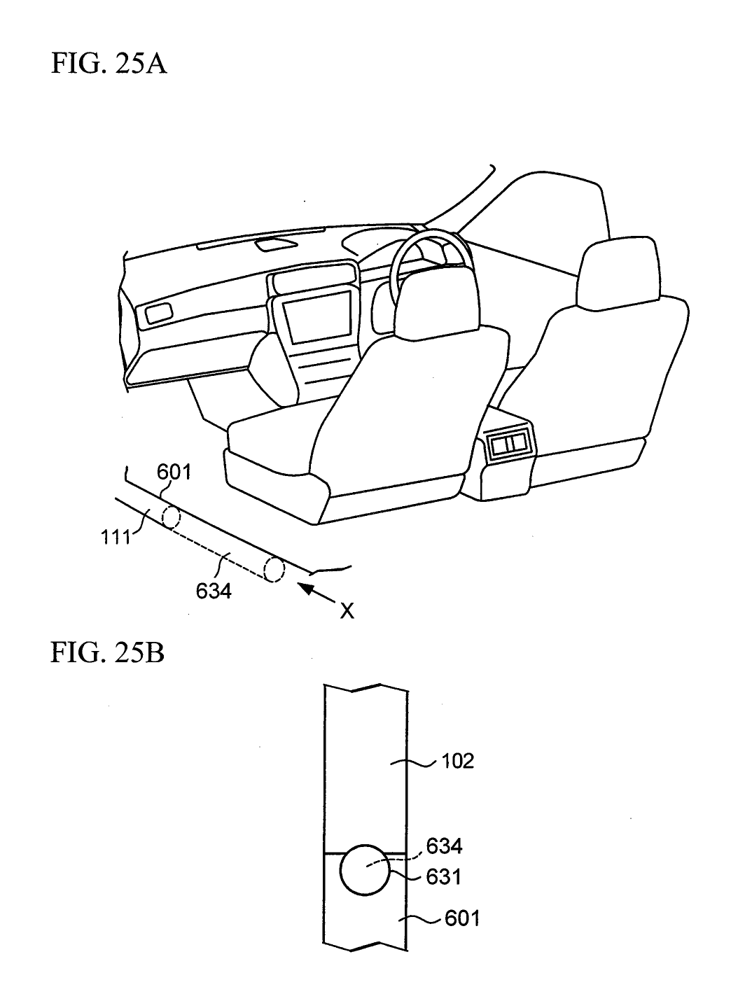

FIG. 25A shows a variation of the seventh embodiment, wherein the pipe 631 is disposed in a side-sill 601 of the floor 111 such that the hollow portion 634 thereof extends in the front-back direction of the vehicle 100. FIG. 25B is an illustration of the side-sill 601 viewed in the X-direction of FIG. 25A.

### 8. Eighth Embodiment

An eighth embodiment is characterized in that a sound absorber SA_8 is installed in an instrument panel 700 disposed below a front glass 105F in the compartment 105 of the vehicle 100.

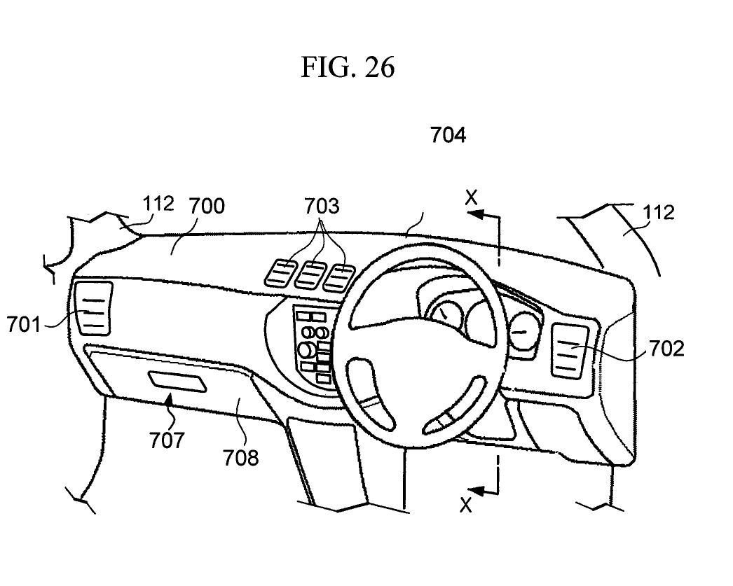

FIG. 26 is a perspective view showing the external appearance of the instrument panel 700. The sound absorber SA_8 is disposed in a space S between the instrument panel 700 and the engine partition 116.

The instrument panel 700 is equipped with various instruments, speakers 701 and 702 of an audio device, and warm/cool air outlets 703. A plurality of defroster outlets 704 is formed in the upper surface of the instrument panel 700 so as to output a warm air supplied from an air-conditioner unit 705. A glove box 707 is arranged in the lower-left position of the instrument panel 700 and is closed by a cover 708.

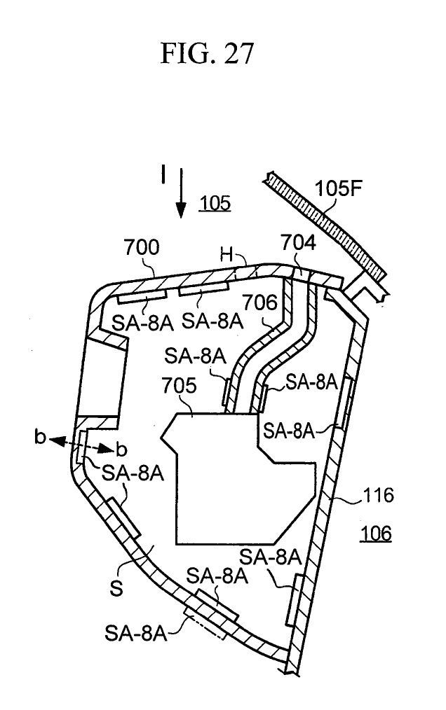

FIG. 27 shows the internal structure of the instrument panel 700 and is a cross-sectional view taken along line X-X in FIG. 24. The air-conditioner unit 705, a defrost duct 706, and a plurality of sound absorbers SA_8A are arranged in the internal space S of the instrument panel 700. The internal space S of the instrument panel 700 communicates with the compartment 105 via a hole H.

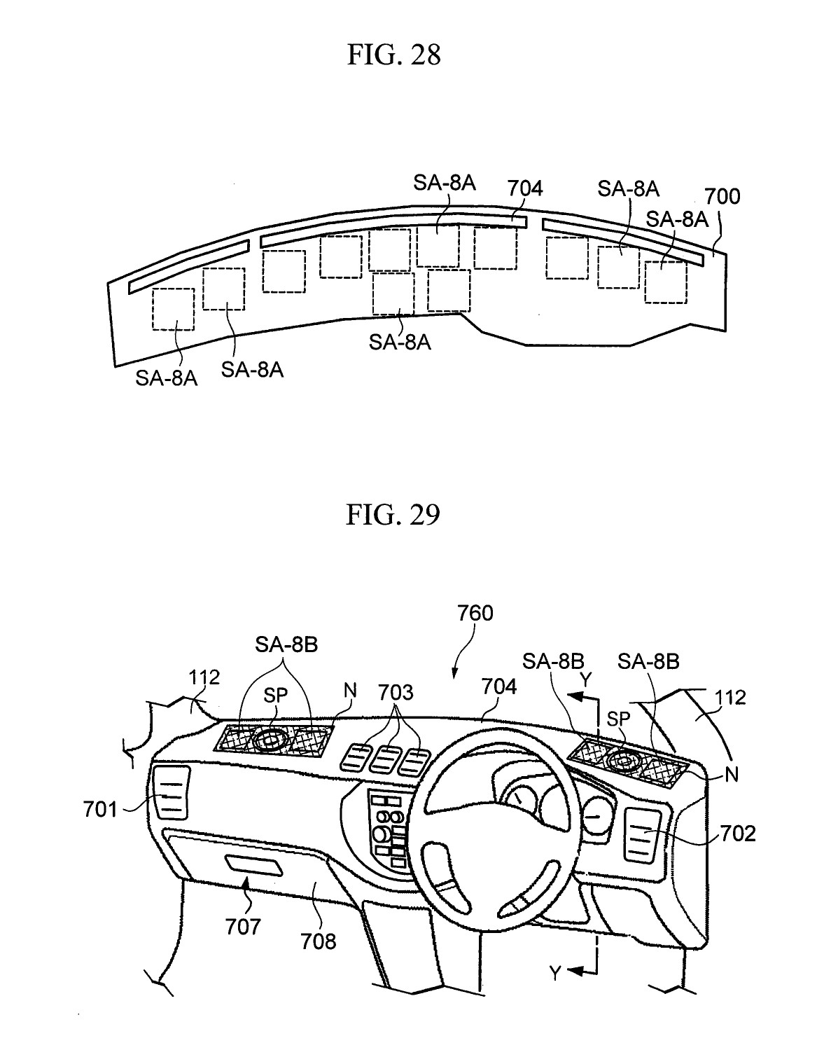

FIG. 28 is an illustration of the instrument panel 700 viewed in the I-direction in FIG. 27, which shows the arrangement of the sound absorbers SA_8A in the upper view. A plurality of sound absorbers SA_8A is disposed in a wide range of area on the upper side of the interior wall of the instrument panel 700. In addition, the sound absorbers SA_8A are disposed in proximity to the defrost duct 706 and the other portion of the interior wall of the instrument panel 700.

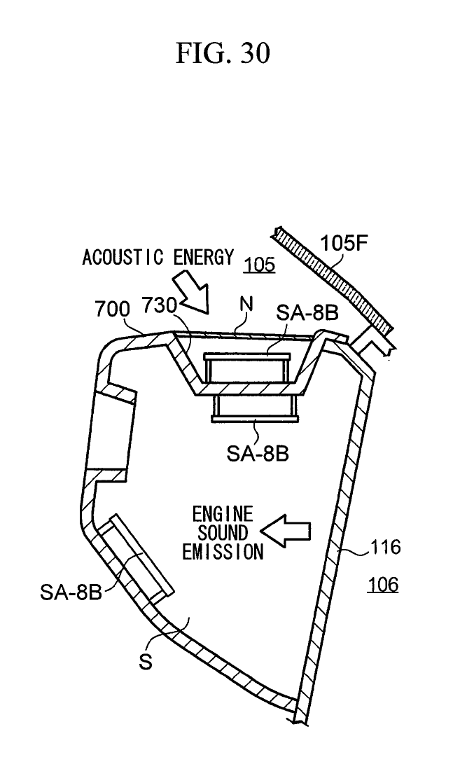

FIG. 29 is a perspective view showing the external appearance of the instrument panel 700 adopting sound absorbers SA_8B according to a variation of the eighth embodiment. A speaker SP together with two sound absorbers SA_8B are disposed on each of the right and left sides of the upper surface of the instrument panel 700. FIG. 30 is a cross-sectional view taken along line Y-Y in FIG. 27, which shows the internal structure of the instrument panel 700. A recess 730 is formed in each of the right and left sides of the upper surface of the instrument panel 700. One speaker SP and two sound absorbers SA_8B are disposed inside the recess 730, the opening of which is covered with a net N. The other sound absorbers SA_8B are disposed on the interior wall of the instrument panel 700 as well. In this constitution, the sound absorbers SA_8B consume acoustic energy propagated from the compartment 105 and energy of an engine sound emitted from the engine room 106 via the engine partition 116, thus achieving sound absorption.

In the above, the sound absorbers SA_8B are not necessarily disposed in the recess 730 holding the speaker SP; hence, they can be disposed in another space for arranging instruments and the like. The sound absorbers SA_8B are not necessarily covered with the net N; hence, they can be rearranged to communicate with the compartment 105 via a grill, mesh, and slits.

### 9. Ninth Embodiment

A ninth embodiment is characterized in that a three-dimensional sound absorbing structure is formed by combining a plurality of sound absorbers.

Specifically, a panel-vibration sound absorbing structure 800 according to the ninth embodiment includes a plurality of sound absorbers 820 in a housing 810 thereof.

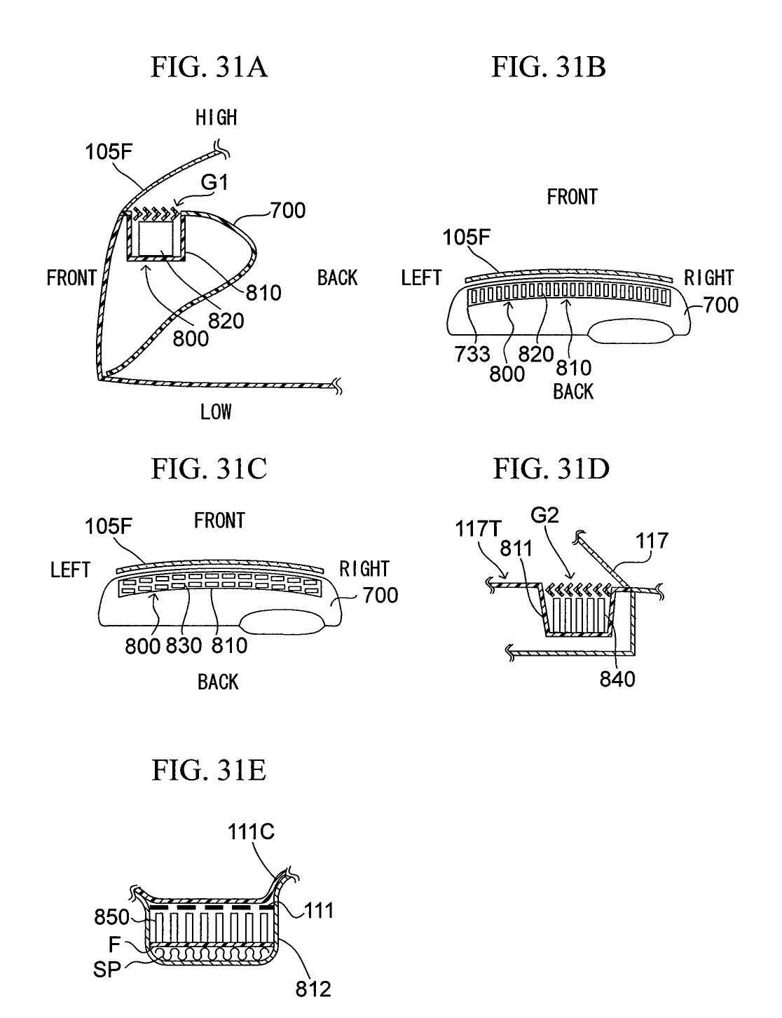

Examples for attaching the present embodiment to various positions of the vehicle 100 will be described with reference to FIGS. 31A to 31E. FIG. 31A is a cross-sectional view of the instrument panel 700 equipped with the panel-vibration sound absorbing structure 800, and FIG. 31B is an upper plan view of the instrument panel 700.

As shown in FIGS. 31A and 31B, the housing 810 of the panel-vibration sound absorbing structure 800 is attached to a lower position of the instrument panel 700, wherein an elongated hole 733 which is elongated in the longitudinal direction is formed in the instrument panel 700 in proximity to the boundary of a front glass 105F and is covered with a grill G1. The housing 810 is curved in the longitudinal direction, and the opening thereof has substantially the same dimensions as the elongated hole 733 of the instrument panel 700. That is, the panel-vibration sound absorbing structure 800 is attached to the lower position of the instrument panel 700 in such a way that the opening of the housing 810 is positioned opposite to the elongated hole 733 of the instrument panel 700.

A plurality of sound absorbers 820 is disposed in the housing 810 such that the vibration surfaces thereof are perpendicular to a virtual opening plane encompassed by the opening edge of the housing 810. Specifically, the vibration surfaces of the sound absorbers 820 are disposed in parallel with the front-back direction of the vehicle 100, wherein the sound absorbers 820 are disposed in the housing 810 along the elongated hole 733 of the instrument panel 700 in the right-left direction of the vehicle 100.

By arranging two or more sound absorbers 820 per unit area corresponding to the surface area of the sound absorber 820 in the housing 810, it is possible to achieve the panel-vibration sound absorbing structure 800 having a high sound absorption coefficient. It is preferable that the panel-vibration sound absorbing structure 800 of the present embodiment be disposed at a predetermined position at which sound pressure tends to increase in the vehicle 100. Since the sound absorbers 820 are disposed in the housing 810 such that the vibration surfaces thereof cross the opening plane of the housing 810, it is possible to appropriately change the directions of disposing the sound absorbers 820. In FIG. 31C, a plurality of sound absorbers 830 is disposed in the housing 810 of the panel-vibration sound absorbing structure 800 such that the vibration surfaces thereof are aligned in parallel with the left-right direction of the vehicle 100. Of course, it is possible to align the sound absorbers 820 and 830 such that their vibration surfaces are not perpendicular to the opening plane of the housing 810.

FIG. 31D shows an example in which a tray 117T beneath the rear glass 117 of the vehicle 100 serves as a housing 811 of the panel-vibration sound absorbing structure 800. The opening of the housing 811 is covered with a grill G2. A plurality of sound absorbers 840 is disposed in the housing 811 so as to effectively reduce noise in the rear seat of the vehicle 100.

FIG. 31E shows an example in which a housing 812 of the panel-vibration sound absorbing structure 800 is disposed beneath the floor 111 of the vehicle 100. The floor 111 is equipped with a perforated metal so as to achieve acoustic transmissivity, wherein a floor carpet 111C is attached to the upper surface of the floor 111. The housing 812 is attached beneath the floor 111 such that the opening thereof is directed to the floor 111. In order to increase a sound absorption effect, a felt F is adhered to the bottom of the housing 812 and is covered with a sound insulation layer SP composed of a rubber sheet, so that a plurality of sound absorbers 850 is aligned on the sound insulation layer SP. In this constitution, it is possible to effectively reduce road noise entering into the compartment 105 from below the vehicle 100.

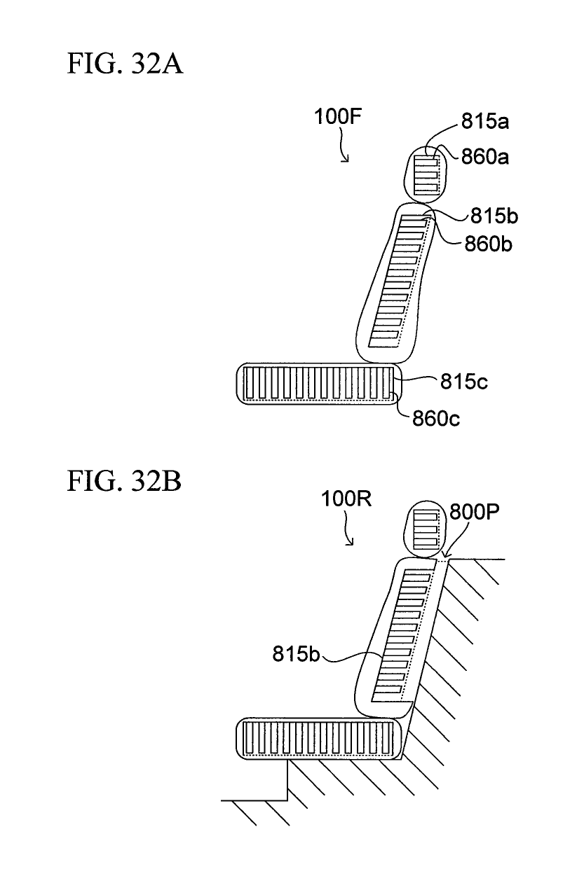

FIG. 32A shows that a panel-vibration sound absorbing structure 800A having a plurality of housings 815a, 815b, and 815c is installed in a front seat 100F of the vehicle 100. Grill-shaped openings (drawn with dotted lines) are formed in the front seat 100F in proximity to the openings of the housings 815a, 815b, and 815c. A plurality of sound absorbers 860a is disposed in the housing 815a; a plurality of sound absorbers 860b is disposed in the housing 815b; and a plurality of sound absorbers 860c is disposed in the housing 815c. In this constitution, it is possible to absorb noise in the compartment 105, and it is possible to reduce acoustic energy transmitted to a human body from the front seat 100F.

FIG. 32B shows an example in which sound waves such as noise are guided to a panel-vibration sound absorbing structure 800B installed in a rear seat 100R so as to effectively absorb sound. The overall constitution of the panel-vibration sound absorbing structure 800B is roughly identical to that of the panel-vibration sound absorbing structure 800A. An opening 800P is formed in the upper section of a space formed in the backside of a back support of the rear seat 100R, wherein the space communicates with the opening of the housing 815b. When sound waves enter into the backside of the rear seat 100R via the opening 800P in proximity to the rear seat 100R, it is possible to effectively suppress them.

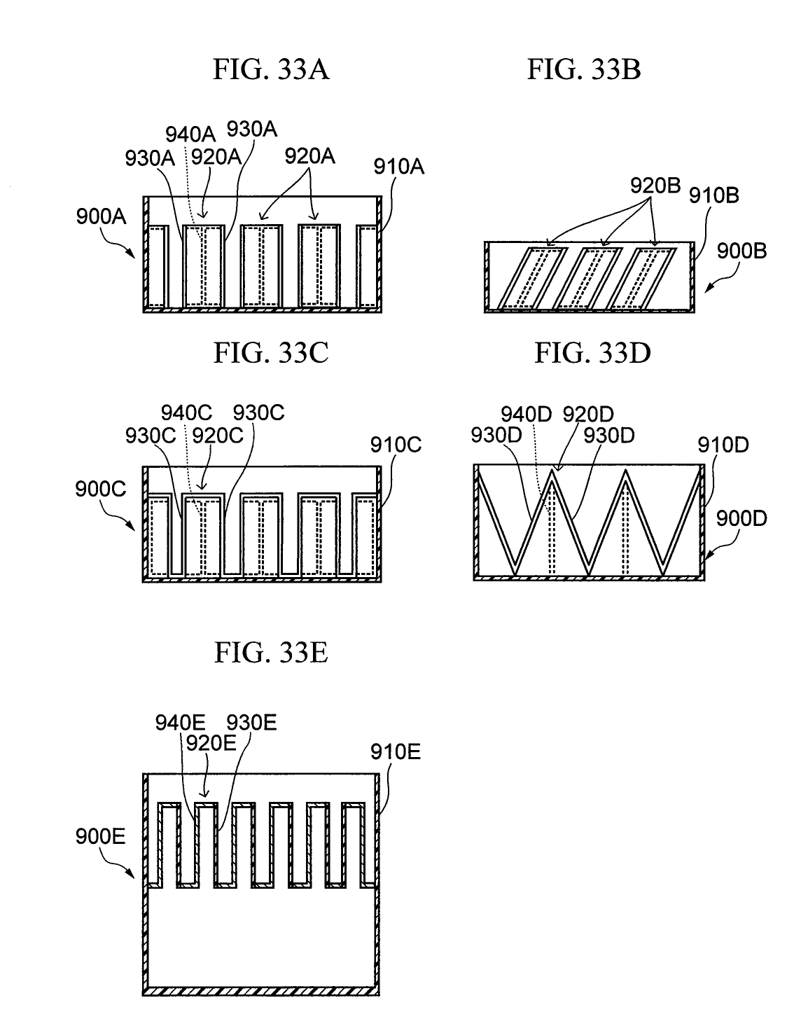

Next, variations of the present embodiment will be described with respect to the alignment of sound absorbers 920 in a housing 910 of a panel-vibration sound absorbing structure 900 in conjunction with FIGS. 33A to 33E.

FIG. 33A shows that a plurality of sound absorbers 920A is disposed in a housing 910A of a panel-vibration sound absorbing structure 900A. The sound absorbers 920A have support members 940A, each of which has a hexahedron shape whose two opposite sides are removed so as to leave four sides, wherein a single surface is formed perpendicular to the center of each of the four sides. When the support member 940A is subjected to cutting in a direction which is perpendicular to one pair of opposite sides within the four sides and in a direction which is parallel to the other pair of opposite sides, the cross-sectional shape thereof is roughly H-shaped. Due to the above constitution of the support member 940A, openings are formed on opposite ends of each side, wherein the sound absorber 920A is assembled in such a way that each opening joins each vibration member 930A.

An opening is formed on one side of the housing 910A. The vibration surfaces of the vibration members 930A are aligned to cross the virtual opening plane encompassed by the edge of the opening of the housing 910A. This makes it possible to easily adjust the number of the sound absorbers 920A disposed in the housing 910A of the panel-vibration sound absorbing structure 900A, thus improving the sound absorption coefficient.

It is possible to incline the positions of the sound absorbers 920A linearly aligned in the panel-vibration sound absorbing structure 900A shown in FIG. 33A. FIG. 33B shows a panel-vibration sound absorbing structure 900B enclosed in a housing 910B in which a plurality of sound absorbers 920B is disposed and inclined in position. This makes it possible to reduce the height without reducing the overall area of the vibration surfaces of the sound absorbers 920B. Thus, it is possible to achieve the panel-vibration sound absorbing structure 900B having a small height and a high sound absorption coefficient.

A plurality of vibration members can be formed using one sheet. Similar to the panel-vibration sound absorbing structure 900A shown in FIG. 33A, a plurality of support members 940C is disposed in a housing 900C of a panel-vibration sound absorbing structure 900C, wherein the support members 940C join together while closing openings thereof by bending one sheet. This produces a panel-shaped structure which is limited in position by the openings of the support members 940C and which is used to form vibration members 930C so as to absorb sound. This constitution allows one sheet to form a plurality of sound absorbers 920C equipped with a plurality of vibration members 930C; hence, it is possible to easily produce the panel-vibration sound absorbing structure 900C.

It is possible to provide different shapes to the support members 940A of the sound absorbers 920A shown in FIG. 33A. In a panel-vibration sound absorbing structure 900D shown in FIG. 33D, panel-shaped support members 940D are attached to the bottom of a housing 910D so as to direct toward the upper opening. A bent sheet is attached to the ends of the support members 940D and the bottom of the housing 910D, thus forming vibration members 930D supported by the support members 940D. This constitution allows one sheet to form a plurality of sound absorbers 920D equipped with a plurality of vibration members 930D inside the housing 910D; hence, it is possible to easily produce the panel-vibration sound absorbing structure 900D.

Since the support member of the sound absorber is used to support the vibration member and to form an air cavity on one side thereof, it is unnecessary to form the air cavity in the surrounding area of the support member. FIG. 33E shows a panel-vibration sound absorbing structure 900E in which sound absorbers 920E are subjected to cutting in a direction perpendicular to each side and the bottom of a housing 910E.

FIG. 33E shows that a pair of opposite sides of the sound absorber 920E is positioned opposite to a support member 940E and that in one side within the opposite sides, the support member 940E is partially cut out in the range from the position which comes in contact with a plane perpendicular to the center of each side to one vibration member 930E, while in the other side, the support member 940E is partially cut out in the range from the position which comes in contact with the plane to the other vibration member 930E. That is, the sound absorber 920E whose support member 940E is partially cut out is integrally unified with the vibration member 930E and is fixed to the center of the side wall of the housing 910E. In the panel-vibration sound absorbing structure 900E of FIG. 33E, the sound absorber 920E is constituted of the vibration member 930E and the support member 940E.

In FIG. 33E, the support member 940E is fixed to the center of the side wall of the housing 910E so that an air cavity is formed between the vibration member 930E and the support member 940E while a relatively large air cavity is also formed beneath the vibration member 930E and the support member 940E (i.e. above the bottom of the housing 910E). This constitution allows the total volume of the air cavities to be easily adjusted, thus easily adjusting the frequency band subjected to sound absorption.

The shape of the vibration member of the sound absorber in the panel-vibration sound absorbing structure is not necessarily limited to the square shape, which can be changed to various shapes such as polygonal shapes, circular shapes, and elliptic shapes. In addition, it is possible to control the frequency band of sound absorption by additionally forming holes in the vibration member and the support member.

Lastly, the present invention is not necessarily limited to the above embodiments and variations, which can be further modified within the scope of the invention as defined in the appended claims.

1. A sound absorbing structure comprising:
a housing having a hollow portion and an opening; and
a vibration member composed of a panel or a membrane,
wherein the opening of the housing is closed with the vibration member so as to form an air cavity, and
wherein a density of at least a part of the vibration member except for a first area causing a node or a minimum amplitude of bending vibration differs from a density of the first area of the vibration member.

2. The sound absorbing structure according to claim 1, wherein a density of the vibration member at a second area causing a maximum amplitude of bending vibration differs from a density of the vibration member except for the second area.

3. A sound absorbing structure comprising:
a housing having a hollow portion and an opening; and
a vibration member composed of a panel or a membrane,
wherein the opening of the housing is closed with the vibration member so as to form an air cavity, and
wherein a thickness of at least a part of the vibration member except for a first area causing a node or a minimum amplitude of bending vibration differs from a thickness of the first area of the vibration member.

4. The sound absorbing structure according to claim 3, wherein a thickness of the vibration member at a second area causing a maximum amplitude of bending vibration differs from a thickness of the vibration member except for the second area.

5. A sound absorbing structure comprising:
a housing having a hollow portion and an opening;
a vibration member composed of a panel or a membrane; and
a secondary member,
wherein the opening of the housing is closed with the vibration member so as to form an air cavity, and
wherein the secondary member is attached to at least a part of the vibration member except for a first area causing a node or a minimum amplitude of bending vibration.

6. The sound absorbing structure according to claim 5, wherein the secondary member is attached to the vibration member at a second area causing a maximum amplitude of bending vibration.

7. The sound absorbing structure according to claim 6, wherein the secondary member is attached to a surface of the second area of the vibration member.

8. The sound absorbing structure according to claim 6, wherein the secondary member is incorporated into the second area of the vibration member.

9. A grouped sound absorbing structure composed of a plurality of sound absorbing structures according to claim 5, wherein the secondary members attached to the sound absorbing structures differ from each other in weight.

10. A grouped sound absorbing structure composed of a plurality of sound absorbing structures according to claim 1.

11. The grouped sound absorbing structure according to claim 10, wherein the air cavities of the sound absorbing structures differ from each other in size.

12. The grouped sound absorbing structure according to claim 10, wherein the air cavities of the sound absorbing structures differ from each other in thickness.

13. A sound chamber including the sound absorbing structure according to claim 1.

14. An adjustment method adapted to a sound absorbing structure which is constituted of a housing having a hollow portion and an opening and a vibration member for closing the opening of the housing so as to form an air cavity and in which a density of at least a part of the vibration member except for a first area causing a node or a minimum amplitude of bending vibration differs from a density of the first area of the vibration member,
wherein the density of at least a part of the vibration member except for the first area is changed so as to adjust a resonance frequency of the sound absorbing structure.

15. (canceled)

16. (canceled)

17. A noise reduction method adapted to a sound absorbing structure which is constituted of a housing having a hollow portion and an opening and a vibration member for closing the opening of the housing so as to form an air cavity, wherein a density of at least a part of the vibration member except for a first area causing a node or a minimum amplitude of bending vibration differs from a density of the first area of the vibration member, thus reducing noise by the vibration member.

18. (canceled)

19. (canceled)

20. A grouped sound absorbing structure composed of a plurality of sound absorbing structures according to claim 3.

21. A grouped sound absorbing structure composed of a plurality of sound absorbing structures according to claim 5.

22. A sound chamber including the sound absorbing structure according to claim 3.

23. A sound chamber including the sound absorbing structure according to claim 5.
